(19) United States
(12) Patent Application Publication
(10) Pub. No.: US 2008/0273167 A1
(43) Pub. Date: Nov. 6, 2008

(54) SURFACE RELIEF DIFFRACTIVE OPTICAL ELEMENTS PROVIDING REDUCED OPTICAL LOSSES IN ELECTRO-ACTIVE LENSES COMPRISING LIQUID CRYSTALLINE MATERIALS

(76) Inventor: ROGER CLARKE, Cambridge (GB)

Correspondence Address: PEARL, COHEN, ZEDEK & LATZER, LLP, 1500 BROADWAY, 12TH FLOOR, NEW YORK, NY, 10036, US

(21) Appl. No.: 12/054,313

(22) Filed: Mar. 24, 2008

Related U.S. Application Data
(60) Provisional application No. 60/924,116, filed on May 1, 2007.

(51) Int. Cl. G02C 7/02; G02B 27/42

(52) U.S. Cl. 351/159; 359/558

(57) ABSTRACT

An electro-active lens has a first substrate with a surface relief diffractive topological profile and a second substrate positioned opposite to the first substrate having a substantially smooth topological profile. A first electrode is positioned along the surface relief diffractive topological profile of the first substrate, and a second electrode is positioned between the first electrode and second substrates. An electro-active material is positioned between the first and second electrodes. The surface relief diffractive topological profile of the first substrate has been modified to eliminate nearly vertical side walls and/or sharp, nearly discontinuous changes in the surface profile, to instead be characterized by sloped side walls and smooth changes in the surface profile, i.e., rounded corners. The radius of curvature of the rounded corners may be, by way of example only, between 1 μm and 100 μm, the slope of the side walls may be at some angle θ, or the shape of the surface profile may be determined by a mathematical smoothing function.

### CROSS REFERENCE TO RELATED APPLICATIONS

This application claims priority under 35 U.S.C. §119(e) from, and incorporates by reference in its entirety, U.S. Provisional Application No. 60/924,116, filed on May 1, 2007 and entitled “Methods for Reducing Optical Losses in Electro-Active Lenses Comprising Liquid Crystalline Materials and Surface Relief Diffractive Optical Elements”.

### BACKGROUND OF THE INVENTION

1. Field of the Invention

The present invention relates to the use of a surface relief diffractive topological profile within an electro-active ophthalmic lens. More specifically, the present invention relates to modifications to surface relief diffractive topological profiles within an electro-active element or electro-active lens to prevent scattering of light in the cholesteric liquid crystal within the electro-active element.

2. Description of the Related Art

Electro-active lenses may be used to correct for conventional or non-conventional errors of the eye. The correction may be created by the electro-active lens, by an optical substrate or the conventional optical lens, or by a combination of the two. Conventional errors of the eye include lower order aberrations such as myopia, hyperopia, presbyopia, and astigmatism. Non-conventional errors of the eye include higher order aberrations that can be caused by ocular layer irregularities.

An electro-active lens is a lens that has alterable optical properties, such as focal length, opacity, etc. The alterable optical properties are provided, in part, by having an electro-active element within the lens. Typically, an electro-active element has electro-active material disposed between electrodes. When an electrical potential is applied between the electrodes of the electro-active element, an electric field is generated. The orientation of molecules in the electro-active material determines optical properties of the material. The molecules of the electro-active material, on average, orient in relation to the applied electric field. In this way, the optical properties of the electro-active material may be altered.

One way of producing an electro-active lens is to provide an electro-active element in combination with a diffractive optic. In such a case, a portion of the lens has electro-active material overlying a surface relief diffractive topological profile. Such a lens typically has one substrate having a surface relief diffractive topology and another substrate having a substantially smooth surface facing the surface relief side. The electro-active material is typically interposed between the two substrates, and the substrates are covered with one or more transparent electrodes. The electro-active lens may include a controller to apply one or more voltages to each of the electrodes and a power supply operably connected to the controller. When electrical energy is applied to the electro-active material by means of the electrodes, the electro-active material's index of refraction may be altered, thereby changing an optical property of the electro-active lens, such as its focal length or diffraction efficiency, for example.

An electro-active element may be capable of switching between a first optical power and a second optical power. The electro-active element may have the first optical power in a deactivated state and may have the second optical power in an activated state. The electro-active element may be in a deactivated state when one or more voltages applied to the electrodes of the electro-active element are below a first predetermined threshold, and the electro-active element may be in an activated state when one or more voltages applied to the electrodes of the electro-active element are above a second predetermined threshold. Alternatively, the electro-active element may be capable of “tuning” its optical power, such that the electro-active element is capable of providing a continuous, or substantially continuous, optical power change between the first optical power and the second optical power. In such an embodiment, the electro-active element may have the first optical power in a deactivated state and may have an optical power between a third optical power and the second optical power in an activated state, wherein the third optical power is above the first optical power by a predetermined amount.

In one embodiment, in the absence of electrical energy, the index of refraction of the electro-active material substantially matches the index of refraction of the surface relief diffractive profile. Such matching results in a canceling out of the optical power provided by the diffractive optic to the lens. The application of electrical energy between the electrodes causes the index of refraction of the electro-active material to differ from that of the surface relief diffractive profile so as to create a condition for incident light to be diffracted (i.e., focused) with high efficiency.

An electro-active element may include a liquid crystal, which is particularly well suited for electro-active lenses because it has an index of refraction that can be altered by generating an electric field across the liquid crystal. A thin layer of liquid crystal (less than 10 μm) may be used to construct the electro-active element. When a thin layer is employed, the shape and size of the electrode(s) may be used to induce certain optical effects within the lens. For example, a diffractive pattern can be dynamically produced within the liquid crystal by using concentric ring shaped patterned electrodes, and such a pattern can produce an optical add power based upon the radii of the rings, the widths of the rings, and the range of voltages separately applied to the different rings.

Alternatively, a single continuous electrode may be used with a specialized optical structure known as a surface relief diffractive optic. A surface relief diffractive optic is a physical substrate which has a diffractive pattern created thereon, for example, by etching, grinding or molding. Such an optic is a physical structure which is patterned to have a fixed optical power and/or aberration correction, by way of a surface relief diffractive topological profile. In such a case, electro-active material overlies the electrode. As discussed above, by applying voltage to the liquid crystal through the electrode, the power/aberration correction can be switched on and off by means of refractive index mismatching and matching, respectively.

Surface relief diffractive optics for such electro-active lenses are known in the art. For example, as shown in FIG. 1, an electro-active element 10 has the electro-active material 12, for example a cholesteric liquid crystalline (CLC) material, positioned between a substrate 6 with a mostly smooth surface and a substrate 4 with a patterned surface relief diffractive optic profile 8. The patterned surface 8 of the substrate 4 could be in the form of a rotationally symmetric diffraction pattern having a pre-determined depth, wherein the pattern period decreases gradually with increasing radius. One patterned surface 8 known in the art has one or more wave forms, as shown in FIGS. 3A and 3B, each having inflection points 23, i.e., peaks and troughs, that are sharp surface discontinuities, with a curved wave form surface and a substantially vertical surface 22 between the inflection points 23 of adjacent wave forms. The surfaces of the two substrates facing the cholesteric liquid crystalline material 12 are each coated with a single optically transparent electrode 14,16.

Such electro-active lenses offer many benefits that include high diffraction efficiency (the fraction of incident light brought to focus), few electrical connections and an uncomplicated device structure. One issue with these devices, however, is that they posses mechanisms for optical losses which affect the overall transmission and cosmetics of the finished lens. One possible loss mechanism is scatter from the cholesteric liquid crystalline material that is poorly aligned throughout the bulk of the material. In order to reduce the amount of scatter, liquid crystal alignment layers are typically used. Alignment layers act to align the director (a unit magnitude vector which describes the average direction of orientation of the liquid crystal molecules over some volume) on a surface and are typically processed from solution.

Another source of light scatter is poor alignment of the cholesteric liquid crystalline material at the inflection points 23 of the surface relief diffractive optic. Surface relief diffractive optical structures, such as those shown in FIG. 3A, typically achieve peak performance (i.e. diffraction efficiency) when the inflection points, i.e., peaks and troughs, of adjacent wave forms are connected by nearly vertical side walls 22 and sharp, nearly discontinuous changes in the surface profile, as shown in FIG. 3B. However, such geometries do not facilitate well behaved cholesteric liquid crystalline alignment, and disclinations, which are alignment domain boundaries, in the cholesteric liquid crystalline material may result, leading to increased optical scatter.

There is therefore a great need in the art for providing a surface relief diffractive optic for an electro-active lens that achieves high performance efficiency but avoids optical scattering, typically caused by vertical side walls and sharp, nearly discontinuous changes in the profile of the surface relief diffractive optic.

### SUMMARY OF THE INVENTION

Accordingly, this invention provides an improved electro-active lens for effectively overcoming the aforementioned difficulties and problems inherent in the art.

In one embodiment of the present invention, a first substrate for an electro-active lens has a surface relief diffractive topological profile with sloped side walls and smooth changes in the surface profile.

In certain embodiments of the invention, implementation of sloped side walls and rounded corners may be undertaken only in regions where the size of the diffractive zones are such that they can be resolved by the human eye.

In certain other embodiments of the invention, the angle of the sloped side wall of the surface relief diffractive topological profile may be, by way of example only, <45°.

In certain other embodiments of the invention, the smoothed corners of the surface relief diffractive topological profile may be characterized by rounded corners, which are defined by a radius of curvature. In certain embodiments, the radius of curvature of the rounded corners may be, by way of example only, between 1 μm and 100 μm.

In certain other embodiments of the invention, the substrate's surface relief diffractive topological profile has either rounded corners or sloped side walls, but not both in combination.

In another embodiment of the present invention, an electro-active lens has a first substrate having a surface relief diffractive topological profile and a second substrate with a substantially smooth topological profile positioned opposite to the first substrate facing the surface relief diffractive topological profile. A first electrode is positioned along the surface relief diffractive topological profile of the first substrate, and a second electrode is positioned between the first electrode and the second substrate. The surface relief diffractive topological profile of the first substrate has sloped side walls and smooth changes in the surface profile, i.e., rounded corners.

While a surface relief diffractive structure having sloped side walls and smooth changes (rounded corners) in the surface profile may exhibit slightly lower diffraction efficiency than one with nearly vertical side walls and sharp, nearly discontinuous changes in the surface profile, the improved cholesteric liquid crystalline alignment may reduce the optical scatter and improve the overall transmission and cosmetics of the finished lens.

In certain embodiments of the invention, a mathematical smoothing function may be used to alter the shape of the surface profile for reducing optical scatter. Such functions will be smoothly varying functions and may include linear functions, polynomial functions, trigonometric functions, logarithmic functions, or hyperbolic functions.

The present invention will be better understood by reference to the following detailed discussion of specific embodiments and the attached figures, which illustrate and exemplify such embodiments.

### BRIEF DESCRIPTION OF THE DRAWINGS

Embodiments of the invention will be understood and appreciated more fully from the following detailed description in conjunction with the figures, which are not to scale, in which like reference numerals indicate corresponding, analogous or similar elements, and in which:

FIG. 1 shows a schematic cross-section of a prior art electro-active lens having an electro-active element located between a first substrate with a mostly smooth surface and a second substrate with a patterned surface;

FIG. 2 shows a schematic exploded cross-section of a prior art electro-active lens having an electro-active element located between a first substrate with a mostly smooth surface and a second substrate with a patterned surface;

FIG. 3A shows a schematic cross-section of a prior art substrate with a patterned surface that is used in an electro-active lens;

FIG. 3B shows a close up of the surface relief diffractive topological profile of FIG. 3A;

FIG. 4A shows a schematic drawing of a first embodiment of a surface relief diffractive topological profile of the present invention;

FIG. 4B shows a schematic drawing of a second embodiment of a surface relief diffractive topological profile of the present invention;

FIG. 4C shows a schematic drawing of a third embodiment of a surface relief diffractive topological profile of the present invention;

FIG. 5 shows a schematic drawing of a further embodiment of the surface relief diffractive topological profile of a second substrate wherein the sloped side walls and smooth changes in the surface profile are shown as having been formed by a smoothing function;

FIG. 6A shows a schematic drawing of a surface relief diffractive topological profile of a substrate for use in an electro-active lens;

FIG. 6B shows a schematic drawing of a surface relief diffractive topological profile of a substrate wherein the sloped side walls and smooth changes in the surface profile are formed by a smoothing function;

FIG. 6C shows a schematic drawing of the substrate diffractive profile shown in FIG. 6A superimposed over the substrate diffractive profile determined using a smoothing function shown in FIG. 6B;

FIG. 7A shows a schematic drawing of a surface relief diffractive topological profile of a Fresnel lens;

FIG. 7B shows a schematic drawing of a surface relief diffractive topological profile of a Fresnel lens wherein the sloped side walls and smooth changes in the surface profile are formed by a smoothing function; and

FIG. 7C shows a schematic drawing of the substrate diffractive profile shown in FIG. 7A superimposed over the substrate diffractive profile determined using a smoothing function shown in FIG. 7B.

### DESCRIPTION OF THE PREFERRED EMBODIMENT

The following preferred embodiments as exemplified by the drawings are illustrative of the invention and are not intended to limit the invention as encompassed by the claims of this application.

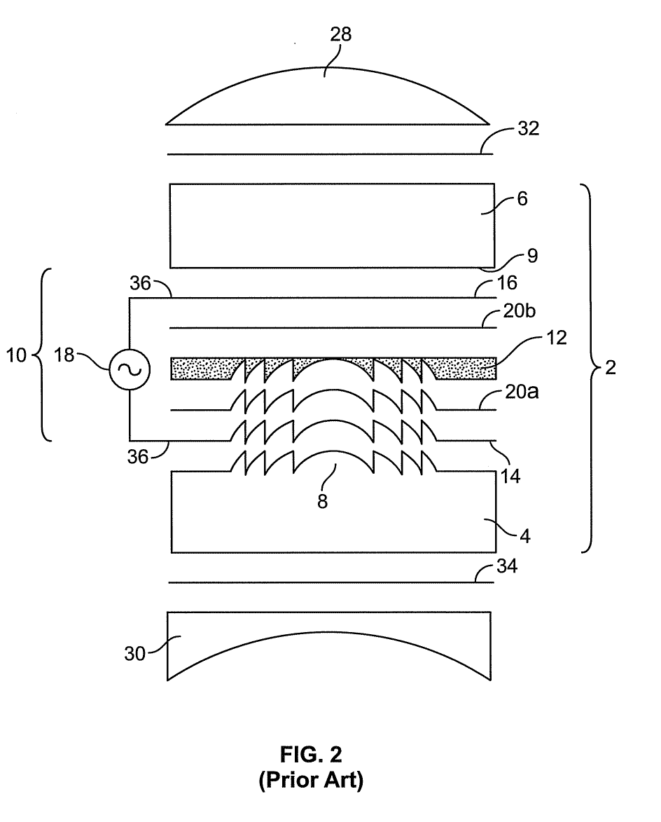

FIG. 2 shows a schematic exploded cross section of an electro-active lens 2 as known in the art. The electro-active lens may include a first substrate 4 and a second substrate 6 positioned on opposite sides of the lens. The first substrate 4 may have a surface relief diffractive topological profile 8 for diffracting light. As shown in FIG. 3A and more closely in FIG. 3B, the surface relief diffractive profile 8 possesses nearly vertical side walls 22 and inflection points having sharp, nearly discontinuous changes in the surface profile 23, i.e., sharp corners. Having “discontinuous changes” is to be understood herein mathematically as a point at which the first derivative is essentially infinite. In addition, the surface relief diffractive pattern may be considered to have a depth modulation of a maximum thickness, d. The second substrate may have a substantially smooth topological profile 9. The smooth topological profile 9 of substrate 6 faces the surface relief diffractive profile 8 of substrate 4. Each of the substrates may have fixed optical properties, such as a refractive index (n) approximately equal to 1.67. The substrates may be composed of materials including, for example, A09 (manufactured by Brewer Science, having n=1.66) or alternatively the commercially available ophthalmic lens resin MR-10 (manufactured by Mitsui, having n=1.67).

The electro-active lens may include an electro-active element 10 positioned between the first and second substrates 4,6. The electro-active element 10 is preferably embedded therein. The first and second substrates 4,6 may be shaped and sized to ensure that the electro-active element 10 is contained within the substrates 4,6 and that contents of the electro-active element 10 cannot escape. The first and second substrates 4,6 may also be curved such that they facilitate incorporation of the electro-active element 10 into a spectacle lens, which is typically curved.

The electro-active element 10 includes one or more electrodes 14 and 16 positioned along the first and second substrates 4,6, respectively. The electrodes 14,16 may form continuous film layers conforming to the surfaces of their respective substrates 4,6. In this example, electrode 16 follows the substantially smooth topological profile 9 of the second substrate 6, and electrode 14 follows the surface relief diffractive topological profile 8 of the first substrate 4. Thus, the electrode 14 conforms to the surface relief diffractive pattern.

One of the electrodes may act as a ground electrode, and the other may act as a drive electrode. The electrodes 14,16 are typically optically transparent. The electrodes may, for example, include any of the known transparent conductive oxides (e.g., indium tin oxide (ITO)) or a conductive organic material (e.g., poly(3,4-ethylenedioxythiophene) poly(styrenesulfonate) (PEDOT:PSS) or carbon nano-tubes). The thickness of each of the electrodes may be, for example, less than 1 micron (μm) but is preferably less than 0.1 μm.

The electro-active lens 2 typically should include drive electronics 18, including a controller and a power supply, for applying one or more voltages to each of the electrodes and for generating a voltage potential across the electrodes. The drive electronics 18 are electrically connected to the electrodes 4,6 by electrical connections 36. The electrical connections 36 may include wires or traces, or the equivalent. Such connections may also be transparent.

The drive electronics 18 apply voltage potentials to the electrodes 4,6 having amplitude in a range of from approximately 6 volts to approximately 20 volts. The voltage potentials should be sufficient for forming an electric field across the electro-active material yet be insufficient for the electrodes 4,6 to conduct. The drive electronics 18 may apply either alternating current (AC) or direct current (DC) to the electrodes.

The lens may also include alignment layers 20a and 20b positioned between the electro-active material 12 and the electrodes 14 and 16, respectively. Alignment layer 20a is shown as following the topological profile of electrode 14. The alignment layer 20b is shown following the topological profile of electrode 16. The lens may alternatively include only a single alignment layer.

The alignment layers 20a and 20b are typically thin films, and, for example, each alignment layer may be less than 100 nanometers (nm). Alignment layers 20a and 20b are preferably less than 50 nm thick. The alignment layers are preferably constructed, for example, from a polyimide material.

The alignment layers 20a and 20b are typically buffed in a single direction (the alignment direction) with a cloth such as velvet. When the molecules of the electro-active material come in contact with the buffed polyimide layer, the molecules preferentially lie in the plane of the substrate and are aligned in the direction in which the alignment layers were rubbed. Alternatively, the alignment layers may be constructed of a photosensitive material, which when exposed to linearly polarized ultraviolet (UV) light, yield the same result as when buffed alignment layers are used.

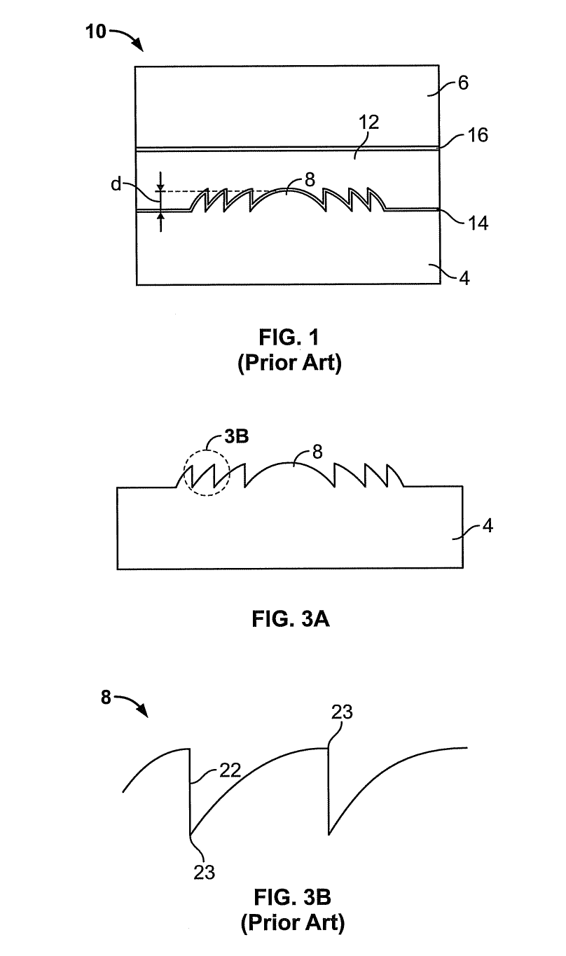

The electro-active lens 2 may also be positioned between a first and a second refractive optic 28,30, e.g., front and back lens components, respectively, for refracting light. The electro-active lens 2 may be embedded within the first and second refractive optics. The lens includes suitable adhesive layers 32 and 34 for securing the electro-active lens to the first and second refractive optics, respectively. Each of the first and second refractive optics and the adhesive layers may have refractive indices that match the average refractive index, n_{avg}, of the electro-active material (e.g., n_{avg}=1.67 for cholesteric liquid crystalline material). FIG. 1 thus shows an electro-active spectacle lens, in which the bulk refractive components that correct for static refractive errors of the eye, i.e., first and second refractive optics 28,30, are attached to the electro-active optic 2 with suitable adhesive layers 32,34.

The first and/or second refractive optics 28,30 may be adapted for blocking the transmission of UV electromagnetic radiation. The UV radiation is known to potentially damage some electro-active materials, materials used for the alignment layers, and materials used for the insulating layers (especially if the materials include organic compounds). The refractive optics may be formed from materials that inherently block such radiation. Alternately, the refractive optics may be coated or imbibed with additional material (not shown) for blocking the UV radiation. Such UV blocking materials are well known in the art and include, for example, UV Caplet II and UV crystal clear (available from Brain Power Inc. (BPI)).

The cholesteric liquid crystals demonstrate a critical limitation in that they typically do not properly align to surfaces with discontinuities. As such, the cholesteric liquid crystals display poor alignment at the peaks and troughs of typical diffractive profiles. This results in a consequent decrease in optical performance by means of increased light scatter. For this reason, although surface relief diffractive optical structures, such as those shown in FIG. 3A and more closely in FIG. 3B, typically achieve peak performance when the inflection points possess nearly vertical side walls and sharp, nearly discontinuous changes in the surface profile, when such geometries are used in conjunction with liquid crystals, such peak optical performance is compromised.

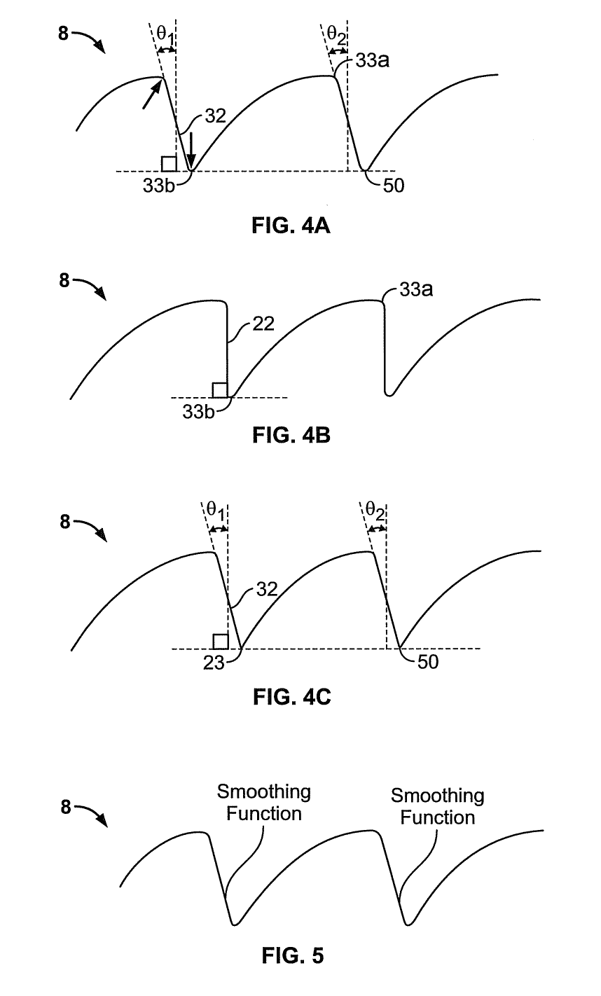

The present invention addresses this problem, by modifying the surface relief diffractive optic topological profile 8 of the substrate 4, shown in FIGS. 3A and 3B. As shown in FIGS. 4A and 4B, the topological profile 8 is formed so that it does not have sharp, nearly discontinuous changes in the surface profile, particularly at the crest inflection points 33A and at the trough inflection points 33B. Instead, in a first embodiment, as shown in FIG. 4B, the surface relief diffractive optic topological profile may have smooth, i.e., not discontinuous, changes in the surface profile at one or both of the inflection points, as opposed to being sharp and nearly discontinuous. Such smooth changes are manifested in rounded corners 33 at one or both of the crest and trough of the topological profile.

In certain embodiments of the invention, the smoothed or rounded corners 33 may be characterized by a radius of curvature r, as shown in FIG. 4A. Such a radius of curvature may be the same at all crests and troughs, may be the same at the crest and trough of each individual diffractive zone, may be the same for all crests and for all troughs but different between the crests and the troughs, or may be different among all the crests and troughs. In certain preferred embodiments, the radius of curvature r may be, by way of example only, in the range of about 1 μm to about 100 μm.

Alternatively, the surface relief diffractive optic topological profile of the present invention may be formed so that the side walls 32, i.e., the surface between the inflection points 23 of adjacent diffractive zones, are not nearly vertical with respect to the plane of the substrate 50. Instead, as shown in FIG. 4C, the surface relief diffractive topological profile may have side walls 32 that are sloped with respect to the vertical. In certain embodiments of the invention, the sloped side wall 32 of each of n diffractive zones has an angle θₙ with respect to the vertical, as shown in FIGS. 4A and 4C. Angle θₙ may be the same for all the sloped side walls of all diffractive zones or may be different among all the diffractive zones such that wave forms 1, 2 . . . n have angles θ₁, θ₂ . . . θₙ. In certain preferred embodiments, the angles with respect to the vertical may be, by way of example only in the range of from about 1° to about 45°, and may preferably be about 20°.

In an alternative embodiment, the surface relief diffractive topological profile of the present invention may be formed so that it has both smooth changes in the surface profile, manifested in rounded corners 33 at both the crest and trough of the topological profile, and somewhat sloped side walls 32, i.e., at angle θ with respect to the vertical, as shown in FIG. 4A.

In certain embodiments, either rounded corners (FIG. 4B) or sloped side walls (FIG. 4C) may be used in the surface relief diffractive topological profile, although not in combination. Thus, in certain embodiments, the surface relief diffractive optic topological profile is formed to have smoothed or rounded corners 33, with nearly vertical side walls 22. In other embodiments, the surface relief diffractive optic topological profile is formed to have somewhat sloped side walls 32 with respect to the vertical, and the corners at both the crest and trough of the wave form topological profile are nearly sharp and nearly discontinuous 23.

In certain other embodiments of the invention, a mathematical smoothing function may be used to create the shape of the surface profile for reducing optical scatter. Such functions will obviously be smoothly varying functions and may include one or more of the following, by way of example only, linear functions, parabolic functions, polynomial functions, trigonometric functions, logarithmic functions, or hyperbolic functions, which are well known in the art. FIG. 5 shows a diffractive surface profile to which a smoothing function has been applied.

By providing a diffractive optic with fewer sharp corners and/or vertical side walls, improved alignment of the electro-active material will result, thereby reducing the optical scatter and improving the overall transmission and cosmetics of the finished lens. However, a surface relief diffractive structure that has been so formed may exhibit slightly lower diffraction efficiency. Lower diffraction efficiency results in light being diffracted into multiple other diffractive orders, leading to multiple image “ghosts”. Therefore, in certain embodiments of the invention, implementation of sloped side walls and rounded corners may be undertaken only in those regions where the size of the diffractive zones are such that they can be resolved by the human eye (i.e. large diffractive zones). As described below, large diffractive zones can undergo large amounts of smoothing and still retain adequate diffraction efficiency when compared to smaller diffractive zones.

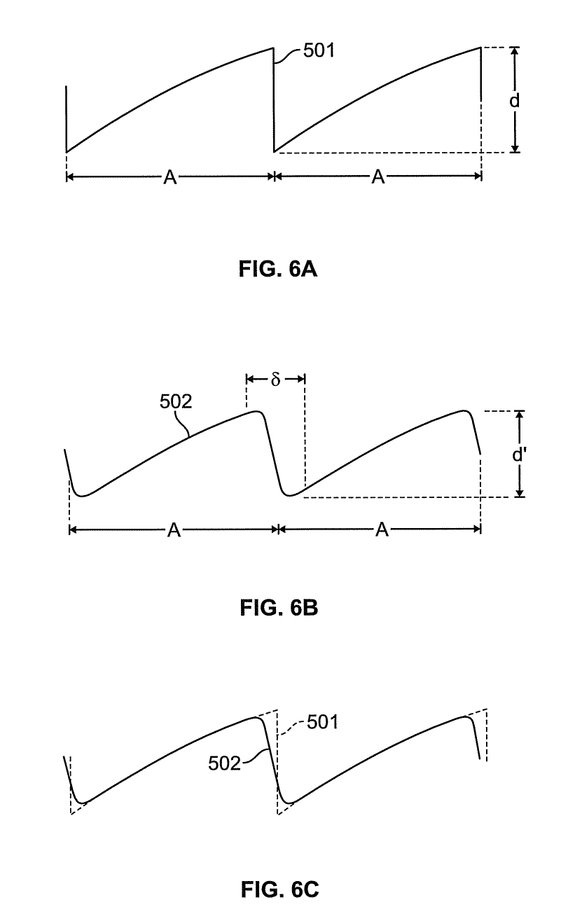

Because the surface relief diffractive structure of FIGS. 4A, 4B or 4C may exhibit slightly lower diffraction efficiency, a balance must be struck between having a profile with rounded corners 33 and/or sloped side walls 32 to minimize optical scattering, but not to such an extent as to cause inefficient diffraction. For example, consider the diffractive profile shown in FIG. 6A, having diffraction period Λ and depth d. Implementing any of the aforementioned changes to reduce optical scatter, namely providing rounded corners and/or sloped side walls, will not alter the fundamental diffraction period Λ (so as not to alter the optical power), as shown in FIG. 6B, but will decrease the depth of the diffractive structure to a new value d′ and introduce a region of width 8 where the diffractive profile differs from that shown in FIG. 6A. FIG. 6C shows the diffractive profile 501 of FIG. 6A superimposed over a smoothed diffractive profile 502 created with a smoothing function of the present invention.

In preferred embodiments of the invention, any changes made to the diffractive profile 501 should be such that δ<0.1×Λ [equation 1] and such that d′>0.9×d [equation 2]. In other words, the depth and/or shape of the smoothed diffractive structure should not deviate more than 10% from the ideal case. While a change in d will only shift the peak in diffraction efficiency away from the design wavelength, drastic changes to the diffractive profile (where δ>0.1×Λ) will cause drastic changes in performance and will cause light to be diffracted more strongly into other unwanted diffractive orders as the diffraction efficiency η will scale as

$$η = {( 1 - \frac{δ}{Λ} )}^{2} . \qquad [ equation 3 ]$$

It is important to properly balance cosmetic appearance against diffraction efficiency. When the corners are heavily smoothed, the scattering is reduced. The result of this is that the lens looks good when viewed by an observer. However, a consequence of heavy smoothing is that when the wearer looks through the lens, they will see “ghosting”, that is, multiple images due to lots of light in higher diffraction orders.

In certain embodiments the criteria outlined in equations 1 and 2 may allow more smoothing to be made in areas of a diffractive region with larger diffractive structures (e.g. towards the center of a lens), thus enabling greater improvement in the cosmetic appearance of the diffractive region.

Experimental work with actual dynamic lenses has shown that when a surface relief diffractive optic with refractive index of 1.67 is in contact with an electro-active element of average refractive index approximately equal to 1.67, a cosine function acts as a suitable smoothing function. Measurements on such lenses show negligible impact on diffraction efficiency when the smoothing function alters the height of the diffractive structures by 6% or less.

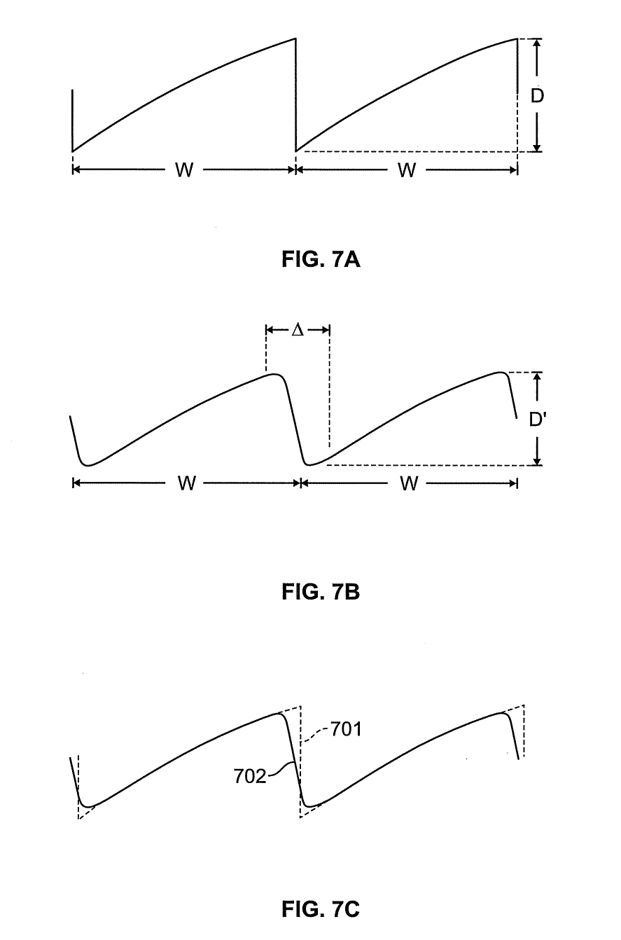

In another embodiment of the invention a surface relief refractive topological profile (a.k.a. a Fresnel lens) may be used in place of a surface relief diffractive topological profile. The shape of the topological profile of a Fresnel lens is nearly identical to that of a diffractive lens (701, FIG. 7C) but differs in that the zones are larger than in the diffractive case (W>>Λ, D>>d, and much larger than the wavelength of light), are not designed to generate an integer multiple of 2π phase shifts, and focus light by means of refraction and not diffraction (i.e. Snell's law applies). Regardless of this fact, any of the aforementioned techniques for reducing optical scatter may be used including the rounding of corners, the sloping of side walls, and the application of smoothing functions (702, FIG. 7C). While by definition a Fresnel lens is 100% efficient and insensitive to changes in its depth (D′, FIG. 7B), the width Δ of any smoothing or blending region (similar to that shown in FIG. 6B) should adhere to the Δ<0.1×W guideline such that light rays are not refracted into unwanted directions. Such unwanted refraction may lead to flaring when a patient looks at a bright optical source while wearing the lenses.

Thus, surface relief diffractive and refractive optical elements providing reduced optical losses in electro-active lenses comprising liquid crystalline materials have been provided. One skilled in the art will appreciate that the present invention can be practiced by other than the described embodiments, which are presented for purposes of illustration and not limitation, and that the invention is limited only by the claim. Further, since numerous modifications and changes will readily occur to those skilled in the art, it is not desired to limit the invention to the exact construction and operation shown and described, and accordingly, all suitable modifications and equivalents may be resorted to, without departing from the scope or spirit of the invention as defined in the appended claims.

What is claimed is:

1) A surface relief diffractive optical element, comprising a topological profile having crests and troughs, wherein at least one of said crest and said trough has a continuous profile.

2) The surface relief diffractive optical element of claim 1, wherein said continuous profile includes a rounded crest.

3) The surface relief diffractive optical element of claim 1, wherein said continuous profile includes a rounded trough.

4) The surface relief diffractive optical element of claim 1, further comprising at least one non-vertical wall positioned between one crest and one trough.

5) The surface relief diffractive optical element of claim 2, wherein the rounded crest has a radius of curvature in the range of from about 1 μm to about 100 μm.

6) The surface relief diffractive optical element of claim 2, wherein the rounded trough has a radius of curvature in the range of from about 1 μm to about 100 μm.

7) The surface relief diffractive optical element of claim 1, wherein said non-vertical wall has an angle is at an angle in the range from about 1° to about 45°.

8) A surface relief diffractive optical element, comprising a surface relief diffractive topological profile having crests and troughs and at least one non-vertical wall therebetween.

9) The surface relief diffractive optical element of claim 8, wherein said profile includes a rounded crest.

10) The surface relief diffractive optical element of claim 8, wherein said profile includes a rounded trough.

11) The surface relief diffractive optical element of claim 9, wherein the rounded crest has a radius of curvature in the range of from about 1 μm to about 100 μm.

12) The surface relief diffractive optical element of claim 10, wherein the rounded trough has a radius of curvature in the range of from about 1 μm to about 100 μm.

13) The surface relief diffractive optical element of claim 8, wherein said non-vertical wall is at an angle in the range from about 1° to about 45°.

14) A surface relief diffractive optical element, comprising a topological profile having crests and troughs and side walls therebetween, wherein the shape of said crests, troughs, and side walls are defined by a smoothly varying mathematical function.

15) The surface relief diffractive optical element of claim 14, wherein said profile includes a rounded crest.

16) The surface relief diffractive optical element of claim 14, wherein said profile includes a rounded trough.

17) The surface relief diffractive optical element of claim 14, further comprising at least one non-vertical wall position between one crest and one trough.

18) A substrate housed in an electro-active element, said substrate comprising a surface having a surface relief diffractive topological profile having crests and troughs, wherein at least one of said crest and said trough has a continuous profile.

19) The substrate of claim 18, wherein said continuous profile includes a rounded crest.

20) The substrate of claim 18, wherein said continuous profile includes a rounded trough.

21) The substrate of claim 18, further comprising at least one non-vertical wall positioned between one crest and one trough.

22) The substrate of claim 19, wherein the rounded crest has a radius of curvature in the range of from about 1 μm to about 100 μm.

23) The substrate of claim 20, wherein the rounded trough has a radius of curvature in the range of from about 1 μm to about 100 μm.

24) The substrate of claim 21, wherein said non-vertical wall has an angle is at an angle in the range from about 1° to about 45°.

25) A substrate housed in an electro-active element, said substrate comprising a surface relief diffractive topological profile having crests and troughs and at least one non-vertical wall therebetween.

26) The substrate of claim 25, wherein said profile includes a rounded crest.

27) The substrate of claim 25, wherein said profile includes a rounded trough.

28) The substrate of claim 26, wherein the rounded crest has a radius of curvature in the range of from about 1 μm to about 100 μm.

29) The substrate of claim 27, wherein the rounded trough has a radius of curvature in the range of from about 1 μm to about 100 μm.

30) The substrate of claim 25, wherein said non-vertical wall is at an angle in the range from about 1° to about 45°.

31) A substrate housed in an electro-active element, said substrate comprising a surface relief diffractive topological profile having crests and troughs and side walls therebetween, wherein the shape of said crests, troughs, and side walls are defined by a smoothly varying mathematical function.

32) The substrate of claim 31, wherein said profile includes a rounded crest.

33) The substrate of claim 31, wherein said profile includes a rounded trough.

34) The substrate of claim 31, further comprising at least one non-vertical wall positioned between at least one crest and one trough.

35) An electro-active lens having an electro-active element, wherein the electro-active element comprises a surface relief diffractive topological profile having crests and troughs, wherein at least one of said crest and said trough has a continuous profile.

36) The lens of claim 35, wherein said continuous profile includes a rounded crest.

37) The lens of claim 35, wherein said continuous profile includes a rounded trough.

38) The lens of claim 35, further comprising at least one non-vertical wall positioned between at least one crest and one trough.

39) The lens of claim 36, wherein the rounded crest has a radius of curvature in the range of from about 1 μm to about 100 μm.

40) The lens of claim 37, wherein the rounded trough has a radius of curvature in the range of from about 1 μm to about 100 μm.

41) The lens of claim 38, wherein said non-vertical wall has an angle is at an angle in the range from about 1° to about 45°.

42) An electro-active lens having an electro-active element, wherein the electro-active element comprises a surface relief diffractive topological profile having crests and troughs and at least one non-vertical wall therebetween.

43) The lens of claim 42, wherein said profile includes a rounded crest.

44) The lens of claim 42, wherein said profile includes a rounded trough.

45) The lens of claim 43, wherein the rounded crest has a radius of curvature in the range of from about 1 μm to about 100 μm.

46) The lens of claim 44, wherein the rounded trough has a radius of curvature in the range of from about 1 μm to about 100 μm.

47) The lens of claim 49, wherein said non-vertical wall is at an angle in the range from about 1° to about 45°.

48) An electro-active lens having an electro-active element, wherein the electro-active element comprises a surface relief diffractive topological profile having crests and troughs and side walls therebetween, wherein the shape of said crests, troughs, and side walls are defined by a smoothly varying mathematical function.

49) The lens of claim 48 wherein said profile includes a rounded crest.

50) The lens of claim 48, wherein said profile includes a rounded trough.

51) The lens of claim 48, further comprising at least one non-vertical wall positioned between at least one crest and one trough.
